(19) United States
(12) Patent Application Publication
(10) Pub. No.: US 2019/0076976 A1
(43) Pub. Date: Mar. 14, 2019

(54) MOTOR SPINDLE FOR A MACHINE TOOL HAVING INTERGRATED COOLING AND A ROTARY FEEDTHROUGH MODULE

(71) Applicant: Franz Kessler GmbH, Bad Buchau (DE)

(72) Inventors: Manuel Gerst, Biberach an der Riss (DE); Udo Tuellmann, Eisenach (DE); Joachim Van Sprang, Ravensburg (DE)

(21) Appl. No.: 16/131,018

(22) Filed: Sep. 13, 2018

(30) Foreign Application Priority Data
Sep. 14, 2017 (DE) 10 2017 008 654.0

(51) Int. Cl. B23Q 37/00; B23Q 5/10; B23Q 1/70; B23Q 11/12

(52) U.S. Cl. CPC B23Q 37/00; B23Q 5/10; B23Q 2705/14; B23Q 11/127; B23Q 2220/006; B23Q 1/70

(57) ABSTRACT

A motor spindle is provided for a machine tool comprising a spindle housing for stationary mounting on the machine, a spindle assembly, removable from the spindle housing, with a rotor that is supported in an integrated bearing unit so as to be rotatable relative to the spindle housing, and a clamping mechanism for a tool, the clamping mechanism being actuatable via a clamping piston that is movable in an annular cylinder in the spindle housing, wherein the spindle assembly is designed with internal cooling that is suppliable with a cooling fluid via a coolant supply, wherein the coolant supply has a rotary feedthrough with an interface between a stationary component and a rotating component of the coolant supply, and wherein the bearing unit is also removable when the spindle assembly is removed from the spindle housing.

### FIELD

The present invention relates to a motor spindle for a machine, in particular for a machine tool, comprising:
a spindle housing for stationary mounting on the machine,
a spindle assembly, removable from the spindle housing, with a rotor that is supported in an integrated bearing unit so as to be rotatable relative to the spindle housing, and
a clamping mechanism for a tool, the clamping mechanism being actuatable via a clamping piston that is movable in an annular cylinder in the spindle housing, wherein the spindle assembly is designed with internal cooling that is suppliable with a cooling fluid via a coolant supply, wherein the coolant supply has a rotary feedthrough with an interface between a stationary component and a rotating component of the coolant supply, and wherein the bearing unit is also removable when the spindle assembly is removed from the spindle housing.

### BACKGROUND OF THE INVENTION

Such a motor spindle is known from the document EP 1 787 744 A. One advantage of this motor spindle is that the spindle assembly together with its integrated bearing unit may be removed as a unit from the spindle housing for maintenance or repair purposes, and subsequently reinserted into the spindle housing without major installation effort. The bearing unit is thus maintained in its configuration, without the need for laborious alignment or tensioning of the bearings when the spindle assembly is reinserted into the spindle housing. In addition, in this motor spindle it is provided that the rotary feedthrough for the coolant supply allows simple removal and reinsertion of the spindle assembly from/into the spindle housing, thereby ensuring a reliable and leak-free coolant supply. However, in this motor spindle from the prior art it has been shown that integrating the rotary feedthrough into the annular cylinder is problematic due to the spatial restriction of the annular cylinder. As a result, the leaking cooling fluid is not easily dischargeable with such an integrated rotary feedthrough. In addition, maintenance or repair of the rotary feedthrough is cumbersome due to the integration within the annular cylinder. This is all the more true due to the fact that the rotary feedthrough contains components that rotate along with the rotating part of the spindle assembly. In addition, possible runout errors of the motor spindle impair the functioning and service life of the rotary feedthrough.

Reference is made to the document EP 1 958 718 B1 as further prior art. This document as well discloses a rotary feedthrough, integrated into the annular cylinder, having the disadvantages described above. In addition, with this prior art a portion of the bearing unit of the spindle assembly remains in the spindle housing, which requires laborious readjustment of the bearing unit when the spindle assembly is reinserted into the spindle housing.

The document EP 2 433 741 A1 describes an arrangement in which the bearing unit of the spindle assembly is inserted via its respective bearing outer rings directly into the spindle housing. This means that the outer rings of the bearings are directly accommodated in the spindle housing. Fretting corrosion may sometimes occur during operation due to vibrations at the outer rings of the bearings, in particular the floating bearings of the particular bearing unit. In such a case the motor spindle, despite the option for replacing the rotor, is unusable due to the fact that the spindle housing, which is specifically intended to remain in the machine, becomes unusable due to the resulting fretting corrosion. In addition, the direct insertion of the bearing outer rings into the spindle housing requires a comparatively large amount of play in order to make the insertion operation, which facilitates simple exchange of the spindle, possible at all. However, such play should be avoided specifically in order to facilitate concentricity. Another disadvantage of this arrangement is that a relatively long, rotatable transfer tube which remains in the spindle housing when the spindle assembly is removed from the spindle housing is provided for the coolant supply. Installation of the spindle assembly in the spindle housing requires careful handling to insert this relatively long transfer tube into the spindle shaft. Lastly, this arrangement also has the above-mentioned disadvantages with regard to integration of the rotary feedthrough within the annular cylinder.

The document EP 0 780 192 A1 likewise describes a motor spindle in which the removal of the spindle assembly is relatively complicated. In particular, in this arrangement, the bearing unit situated close to the rotary feedthrough is detached when the spindle assembly is removed, and must be reinstalled when the spindle assembly is reinserted. In addition, the integration of the rotary feedthrough for the coolant supply within the annular cylinder, with numerous individual parts, is complicated, which makes manufacture expensive, and maintenance difficult.

With regard to the further prior art, reference is made to the documents DE 100 27 750 C5 and DE 195 32 976 A1. These documents describe motor spindles of the conventional type, but without a coolant supply for a cooling fluid. Such uncooled motor spindles have only limited applications due to their tendency, for example, to heat up to an undesirably high level at high spindle rotational speeds.

### BRIEF SUMMARY OF THE INVENTION

It is an object of the present invention to provide a motor spindle of the type mentioned at the outset, and a machine tool having a design for which the structure and the mounting of the rotary feedthrough are more maintenance-friendly and simplified compared to the prior art.

This object is achieved with a motor spindle of the type mentioned at the outset, which provides the option for simple rotor exchange, and in which it is provided that the rotary feedthrough is designed as a rotary feedthrough module that is situated in an area on the spindle housing that is axially outside the annular cylinder.

An important aspect of the present invention is the simple rotor exchange, i.e., the option for removing the spindle assembly from the spindle housing for maintenance purposes, repair purposes, or for replacement, and reinserting the serviced or repaired spindle assembly or a new spindle assembly into the spindle housing, which remains in the machine. This characteristic for simplified rotor exchange is combined with the features described below.

The present invention, with a motor spindle having the characteristic of simplified rotor exchange, i.e., the option for removing the spindle assembly from the spindle housing while leaving the bearing unit intact, takes into account the problem, described above with regard to the prior art, of the small available space when the rotary feedthrough is integrated within the annular cylinder, and provides for modularizing the rotary feedthrough so that it can be handled as a separate unit. Such a rotary feedthrough module according to the present invention may be separately handled as a single unit and mounted at a suitable position on the spindle housing. It is thus possible to provide, on one end of the spindle housing that is remote from the removable spindle assembly, an appropriate fastening opening or a fixing flange in which or on which the rotary feedthrough module is mountable on the spindle housing. For example, it may be provided according to the invention that the rotary feedthrough module is flange-mounted on the end-face side of the spindle housing by means of a mounting flange.

Furthermore, according to the invention the rotary feedthrough module may be manufactured, serviced, and replaced as a separate unit without having to carry out time-consuming corresponding work steps on a rotary feedthrough that is integrated into the spindle housing with a plurality of individual components and individual parts, as is the case with the prior art. As a result, any leaking coolant is more easily dischargeable from such a separate rotary feedthrough module.

According to the invention, the rotary feedthrough is axially spaced apart from the area in which the annular cylinder is situated within the spindle housing. It is thus possible to obtain even greater freedom of design for the annular cylinder, for example in such a way that fairly large, hydraulically active surfaces for actuating a clamping piston accommodated in the annular cylinder are created for the clamping mechanism. Higher tension forces may thus be built up without increasing the overall installation space of the motor spindle in the radial direction.

The above-described disadvantages with regard to the prior art may be overcome by the invention. Thus, the present invention allows the bearing unit to remain intact, and thus also allows direct accommodation of the outer bearing rings of the bearing unit in the spindle housing to be avoided.

One refinement of the invention provides that the bearing unit has a first bearing assembly situated near the rotary feedthrough module, viewed in the axial direction, and a second bearing assembly situated remote from the rotary feedthrough module, via which the rotor is supported relative to the spindle housing. The two bearing assemblies are provided at a sufficient axial distance from one another in order to precisely support the motor spindle.

In addition, in this regard it may be provided that the first and second bearing units each have a bearing bush, rotatably fixedly mounted in the installed state, in which the respective bearing assembly is accommodated, each bearing bush being removable together with the spindle assembly when it is removed from the spindle housing. Due to the arrangement of the bearing assemblies within bearing bushes that are rotatably fixed in the installed state, which are removable together with the spindle assembly, a bearing assembly which is in each case pre-mounted with regard to the bearing tensioning may be provided which allows the spindle assembly to be removed and reinserted as often as desired without readjustment of the bearing units.

In this regard it may preferably be provided that the first and second bearing assemblies each have a pair of roller bearings that are situated in a predetermined orientation relative to one another. In particular, in this regard it is possible for the pair of roller bearings to have two angular contact ball bearings that are accommodated in the bearing bush in an X arrangement or in an O arrangement. As indicated above, one refinement of the invention provides that the pair of roller bearings is accommodated in the associated bearing bush in a mutually fixedly clamped arrangement. In addition, in this regard it may be provided that the bearing bush is pretensionable with at least one spring-pretensioned and/or hydraulically actuatable and/or pneumatically actuatable bearing tensioning device for operating the motor spindle.

One refinement of the invention provides that the spindle assembly is designed with an axial transfer tube which in the mounted state extends from a spindle shaft, passing through the annular cylinder and the clamping piston into the rotary feedthrough module.

To allow the rotary feedthrough module to be mounted in any desired manner in the area of the spindle housing, in particular also at greater axial distances from the removable spindle assembly and also using a relatively long transfer tube, according to the invention it may also be provided that the rotary feedthrough module has a rotary feedthrough bearing unit that directly or indirectly supports the rotating component of the coolant supply with respect to the spindle housing. It is thus possible within the motor spindle to span even greater distances with the rotating components, up to the rotary feedthrough through the transfer tube, without the risk of imbalances or vibrations occurring. As the result of providing the rotary feedthrough bearing unit, vibrations that occur during operation may be prevented from impairing the functioning and service life of the rotary feedthrough.

In this regard, in one advantageous refinement of the invention it may be provided that the transfer tube is accommodated in the rotating component in the rotary feedthrough module and is supported by same. According to one embodiment variant of the invention, it is provided that the rotary feedthrough bearing unit has at least one roller bearing or slide bearing.

To provide a sufficiently seal-tight interface for transferring the cooling fluid, one refinement of the invention provides that the rotary feedthrough is designed to press the rotating component and the stationary component against one another in a sealing manner under elastic force and/or by hydraulic and/or pneumatic means. In the case of an interface that is acted on by elastic force, for example the stationary part is pressed onto the rotating component of the rotary feedthrough in the axial direction via a pretensioned compression spring. Additionally or alternatively, it is possible for the available gaseous or liquid cooling fluid to press the stationary component and the rotating component against one another in a sealing manner. This may take place, for example, only when the cooling fluid exceeds a minimum pressure value. A combination of spring pretension and fluid-dependent pretension is also possible according to the invention.

One refinement of the invention provides that the rotor is provided on a radially outer section with a clamping element, which via a hydraulically, pneumatically, or electromagnetically actuatable actuator is clampable against a retaining section of the spindle housing for nonrotatably fixing the rotor relative to the spindle housing. This aspect of the nonrotatable fixing of the rotor relative to the spindle housing may be considered separately from the aspects of the invention discussed above. Such fixing of the rotor is appropriate, for example, when the spindle assembly is inserted into a lathe for accommodating a rotary tool, for example a turning tool, which in certain machining situations must be secured against undesirable rotational motion.

In this regard, it may also be provided that the clamping element is designed as a radially extending, deformable clamping plate which is rotatably fixedly connected to the rotor, and which via the actuator may be brought into clamping engagement with the retaining section. Such a clamping plate is suitable for being clamped over its circumference for nonrotatable fixing via the actuator. When the clamping plate is released by the actuator, it deforms elastically back into its starting state, and allows frictionless rotation of the rotor relative to the spindle housing.

Furthermore, in this regard it may be provided that the actuator is designed in the form of a piston that is pretensioned into a position that releases the clamping element, and is actuatable by being acted on by a hydraulic or pneumatic fluid. Such an actuator may be pretensioned via an additional spring element into a starting position in which it releases the clamping element.

In individual cases, in automation technology it is necessary to design machines with an inverter or a combination of a rectifier and an inverter. In the context of the present invention, which provides simple removal and simple reinsertion of the spindle assembly from/into the spindle housing, but also independently of this concept, it may be provided to fixedly mount an inverter or a combination of a rectifier and an inverter directly [on the] spindle housing, wherein the inverter or the combination of the rectifier and inverter remain on the spindle housing when the spindle assembly is removed from the spindle housing. In the event of maintenance or a spindle replacement, the rectifier [sic; inverter] or the combination of the rectifier and inverter does not have to be changed out, but instead may be left on the spindle housing. As a result, the maintenance or repair work steps to be carried out may be further significantly simplified. The inverter or the combination of the rectifier and inverter may be provided with an additional controller that is directly associated with these components, and remains on the spindle housing when the spindle assembly is removed.

The invention further relates to a machine tool that is designed with a motor spindle of the above-described type.

The invention further relates to a method for inserting and removing a spindle from a spindle housing for a motor spindle of the above-described type, wherein the rotor together with its bearing unit is removable from the spindle housing, and wherein in addition the rotary feedthrough module is removable from the spindle housing and mountable on same, independently of the rotor.

### BRIEF DESCRIPTION OF THE SEVERAL VIEWS OF THE DRAWINGS

The invention is explained below by way of example with reference to the appended figures, which show the following:

FIG. 1 shows a longitudinal section view, containing an axis, of a motor spindle in the mounted state according to a first embodiment of the invention;

FIGS. 2a through 2c show longitudinal section exploded views, containing an axis, according to FIG. 1, but in various installation states; and

FIG. 3 shows a longitudinal section view, containing an axis, of a motor spindle in the mounted state according to a second embodiment of the invention.

### DETAILED DESCRIPTION OF THE INVENTION

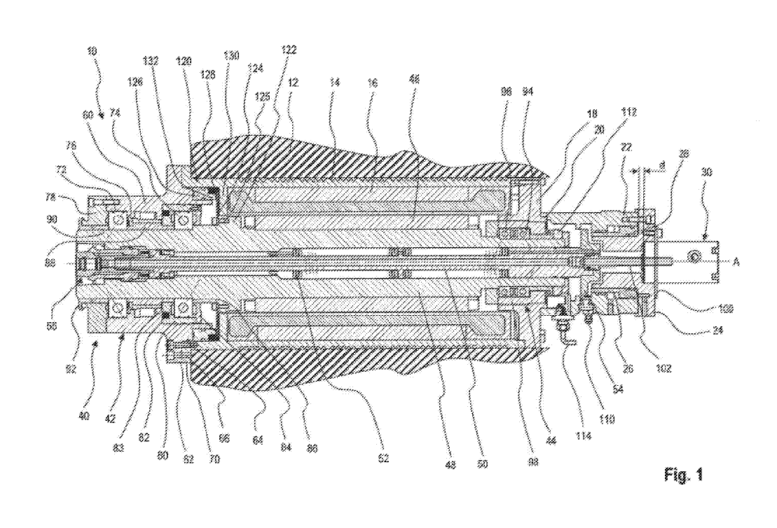

FIG. 1 shows a longitudinal section view, containing the longitudinal axis A, of a motor spindle according to the invention in the mounted state, which is collectively denoted therein by reference numeral 10. The motor spindle 10 according to the invention is situated in a receiving opening of a machine tool 12, indicated strictly schematically in a sectional view, and is fixable at that location.

The motor spindle 10 includes a spindle housing 14 that is stationarily mounted in the machine tool 12. An electromagnetic stator 16 that is electrically controllable in a conventional manner is provided in the spindle housing 14. In addition, the spindle housing 14 includes a flange element 18 that is flange-mounted on the end-face side at the right end of the spindle housing 14 in FIG. 1. The flange element 18 on its radially inner area has a coupling attachment 20 on which a further housing part 22 is mounted. The further housing part 22 together with an insertion part 24 mounted thereon forms a hollow annular cylinder 26 in which a clamping piston 28 is displaceably guided in the axial direction in a sealing manner. The clamping piston 28 is part of a tool clamping system, described in greater detail below, that is integrated into the motor spindle 10.

The insertion part 24 is used for attaching a rotary feedthrough 30, having a modular design, for a cooling fluid for cooling the motor spindle 10; the rotary feedthrough 30 having a modular design is described in greater detail below.

Returning once again to the spindle housing 14, it is apparent that a spindle assembly 40 is situated in the radially inner area of the spindle housing. The spindle assembly 40 as a whole is removable from the spindle housing 14 and insertable into same, for example for maintenance purposes, for repair purposes, or for being completely replaced with another spindle assembly.

The spindle assembly 40 includes a rotor 46 that is supported via a first bearing unit 42 on the left side in FIG. 1 and a second bearing unit 44 on the right side in FIG. 1 so as to be rotatable about the longitudinal axis A. The rotor 46 is designed in a conventional manner and is electromagnetically rotationally drivable by means of the stator 16 by suitable control.

The rotor 46 has a spindle shaft 48 with a hollow design in its interior. A tube element 50, as a component of the tool clamping system, extends through the radially inner area of the spindle shaft 48, and is displaceable relative to the spindle shaft 48 in the axial direction and is pretensioned into a starting state, to the right in FIG. 1, by means of a schematically indicated disk spring assembly 52. The tube element 50 on its right end in FIG. 1 is provided with a flange part 54 that is fixed thereto. The flange part 54 extends far enough radially outwardly that it radially overlaps with the left end of the clamping piston 28 in FIG. 1, and when actuated interacts with the clamping piston. In particular, due to a displacement of the clamping piston 28 to the left in FIG. 1 by the clamping piston 28 being acted on by pressure from hydraulic fluid within the annular cylinder 26 and displaced in the axial direction to the left in FIG. 1, the tube element 50 may be moved to the left in FIG. 1, against the pretensioning force of the disk spring assembly 52, and may thus open a tool clamping mechanism 56, known per se, for inserting a coupling element (not shown) of any given machining tool. When the clamping piston 28 is released, the tool is closed once again in a known manner due to the return effect of the disk spring assembly 52, the tube element 50 being moved back to the right in FIG. 1.

Turning now to the two bearing units 42 and 44, it is apparent that the bearing unit 42 has a bearing housing 60 which in its radially outer area is provided with a flange section 62. The flange section 62 is used to fix the spindle assembly 40, in the installed state, to the spindle housing 14 within the machine tool 12 via multiple fastening screws 64. In addition, the bearing housing 60 contains a series of receiving openings 66 that correspond to corresponding through boreholes 68 in the spindle housing, and via which the entire spindle assembly 40 together with the spindle housing 14 is fastenable to the machine tool with suitable fastening screws. For this purpose, the spindle housing 14 also has a flange section 70 that extends radially outwardly corresponding to the flange section 62 of the bearing housing 60.

The bearing housing 60 in its interior accommodates two angular contact ball bearings 72, 74, which in the example shown are provided in an O arrangement in a manner known per se and tensioned with respect to one another. The angular contact ball bearing 72 with its radially outer bearing shell rests against a radially inwardly extending collar 76 of the bearing housing 60, and is supported on same in the axial direction. The angular contact ball bearing 72 is fixed in the bearing housing 60 via a bearing cover 78. The second angular contact ball bearing 74 is accommodated in a slide bushing 80 so as to be displaceable in the axial direction. The slide bushing 80 is provided over its circumference with a plurality of axial boreholes, wherein a compression spring 82 that acts in the axial direction is accommodated in each of the axial boreholes, and via the compression spring the slide bushing 80 is elastically supported on the right in FIG. 1 on a radially inwardly extending collar 83 of the bearing housing 60. The slide bushing 80 supports the second angular contact ball bearing 74 on the left in the axial direction. From the right, the angular contact ball bearing 74 is held via a bearing disk 84 that is screwed to the slide bushing 80. A shoulder 86 is provided on the spindle shaft 48 for supporting the radially inner bearing shells of the angular contact ball bearings 72, 74. In addition, corresponding spacer sleeves 88, 90 and a spindle disk 92 situated on the end-face side extend on the spindle shaft 48.

The second bearing unit 44, situated on the right in FIG. 1, likewise has two angular contact ball bearings 94, 96 that are provided in an O arrangement and tensioned with respect to one another. The two angular contact ball bearings 94 and 96 are accommodated within the flange element 18, with a slide bushing 98 with slight axial play for axial displacement. The bearing unit 44 forms, in a manner of speaking, a floating bearing for the spindle assembly 40, viewed in the axial direction.

Turning now to the rotary feedthrough module 30, it is apparent that the rotary feedthrough module is insertable into a corresponding opening from the right side in FIG. 1 and into the insertion part 24, and via a fixing plate 100 that is mounted on the rotary feedthrough module 30 in an integral manner or as a separate component is fixable in a flange-like manner to the insertion part 24 by a screw connection. The rotary feedthrough module 30 is connected to the right end of the tube element 50 via a transfer tube 102, so that the cavity in the tube element 50 is fluidically connected via the axially extending cavity in the transfer tube 102 for transferring cooling fluid from the rotary feedthrough module 30. The rotary feedthrough module 30 in its interior has a separate bearing unit (not shown) that supports the transfer tube 102 so that it is rotatable about the longitudinal axis A. It is noted that the transfer tube 102 rotates together with the tube element 50 and the spindle shaft 48 that accommodates it, whereas the housing of the rotary feedthrough module 30 is fixed to the rotatably fixed application [sic; insertion part] 24.

There is an interface between rotating components and rotatably fixed, i.e., stationary, components within the rotary feedthrough module 30. This interface within the rotary feedthrough module 30 is important because a leak-free transfer of the cooling fluid must take place via this interface. A rotating component that accommodates the transfer tube 102 and is rotatably supported within the rotary feedthrough module as well as a rotatably fixed, i.e., stationary, component that may be brought into sealing contact with same are provided for this purpose. The stationary component may be brought into sealing contact with the rotating component by either spring-pretensioning it on the rotating component or by axially tensioning it against the rotating component by supplying the cooling fluid fluidically, i.e., hydraulically or pneumatically, depending on the cooling fluid used. The bearing unit that is provided within the rotary feedthrough module 30 has the advantage that, even when a relatively long transfer tube 102 is used, a vibration- and oscillation-free arrangement of the fluid transfer from the stationary section into the rotating area of the motor spindle 10 is always possible.

In one aspect of the present invention, the rotary feedthrough module 30 is designed separately as a module, so that it may be handled as a unit, and is removable from the insertion part 24 as needed for maintenance, repair, or replacement purposes.

In another aspect of the invention, the rotary feedthrough module 30 does not overlap with the annular cylinder 26 in the axial direction, but instead is situated at a distance d, in the axial direction, from the right end of the annular cylinder in FIG. 1. This has the advantage that the dimensioning of the annular cylinder 26 and of the clamping piston 28 guided therein is possible, regardless of the implementation of the rotary feedthrough of the cooling fluid. This also results in significant advantages with regard to maintenance, since the rotary feedthrough for the internal coolant supply is not implemented within the motor spindle 10 by a complicated arrangement of multiple components, but, rather, by handling of a separate module.

Also apparent in FIG. 1 is a sensor 110 for detecting the instantaneous axial position of the flange part 54. In this way, the instantaneous state of the clamping mechanism 56 and the successful receipt or release of a tool may be detected.

In the immediate vicinity, also apparent is a rotary transducer gearwheel 112 which is fixed in co-rotation on the spindle shaft 48, and which cooperates with a rotational sensor 114, situated in the housing part 22, for detecting the rotational speed of the spindle shaft 48.

Lastly, a clamping mechanism 120 is apparent in FIG. 1 which is provided for fixing the rotor 46 of the motor spindle 10 with respect to the spindle housing 14 as needed. For this purpose, a radially extending, elastically deformable clamping plate 124 is fixed to a radially outwardly extending collar 122 of the spindle shaft 48 via a plurality of screws 125 that are uniformly distributed in the circumferential direction. The spindle housing 14 together with the bearing housing 60 forms a hydraulic chamber in which a clamping piston 126 is displaceably guided in the axial direction in a sealing manner. In the neutral position shown in FIG. 1, the clamping piston 126 is supported on a collar 130 of the spindle housing 14 that extends on a radial insert, via a plurality of axially acting return springs 128. The clamping plate 124 ends radially within the return springs 128, and does not interfere with same. The clamping piston 126 has a clamping section 132 with which the clamping piston may be pressed against the clamping plate 124.

In order to hold the spindle shaft 48, and thus the rotor 46, rotatably fixed with respect to the spindle housing 14, the hydraulic chamber may be acted on by hydraulic fluid, so that the clamping piston 126 is pushed to the right in FIG. 1, against the action of the return springs 128. In the process, by means of the clamping section 132 the clamping piston pushes on the clamping plate 124, which is rotatably fixedly screwed to the spindle shaft 48, on the end-face side and elastically deforms the clamping plate, which is pressed against the lateral surface of the radially inwardly extending collar 130 of the spindle housing 14 facing the clamping plate. The pressing force is selected to be strong enough so that the static friction that acts between the pressed clamping plate 124 and the corresponding surface of the collar 130 is sufficient to hold the spindle shaft 48 in the spindle housing 14 in a rotatably fixed manner. It is thus possible to hold a tool, for example a turning tool, accommodated in the tool clamping mechanism 56 in the motor spindle 10 in a rotatably fixed manner for certain machining steps, if necessary. The hydraulic chamber may subsequently be re-emptied by releasing the hydraulic fluid, wherein the clamping piston 126 under the action of the return springs 128 moves back into its starting position shown in FIG. 1, thereby releasing the clamping plate 124. The clamping plate elastically relaxes and removes the frictional engagement with the collar 130.

The aspect of clamping the rotor 46 by means of the clamping mechanism 120 according to the present invention is understood to be separate from the above-described aspects, and may also be used in motor spindles that are designed without an internal coolant supply and/or without a rotary feedthrough module and/or without the option for simple spindle exchange while leaving the bearing unit intact.

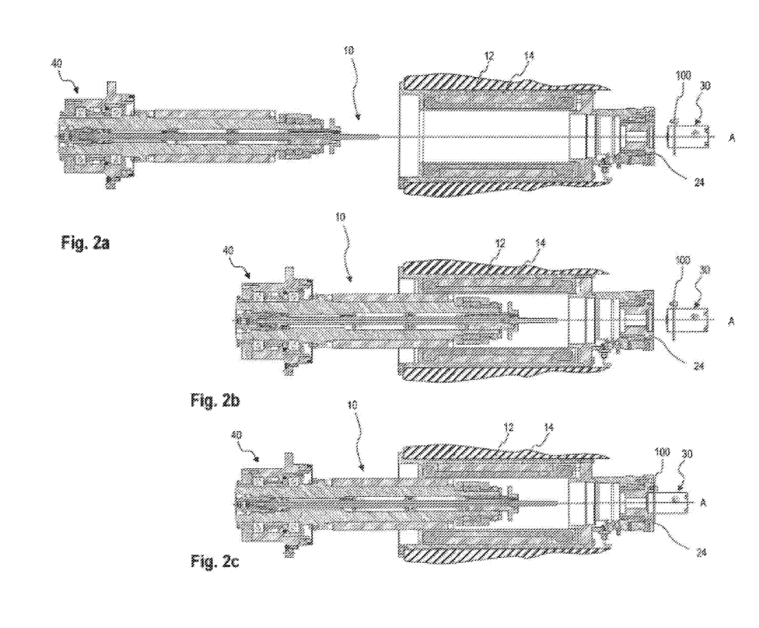

FIGS. 2a through 2c show various installation states of the motor spindle 10 according to the invention.

In FIG. 2a, the spindle housing 14 with its stator 16 is inserted into the machine tool 12. The spindle assembly 40 is removed as a whole in the axial direction from the module made up of the spindle housing 14 and the stator 16, with the bearing units 42 and 44 in their installed state remaining completely intact. In addition, the rotary feedthrough module 30 has been removed by detaching the fixing plate 100 from the insertion part 24.

FIG. 2b shows a state in which the spindle assembly 40 is partially inserted into the module made up of the spindle housing 14 and the stator 16. The rotary feedthrough module 30 is still separate from the insertion part 24.

FIG. 2c shows a state in which the rotary feedthrough module 30 is inserted into the insertion part 24, with the spindle assembly 40 still being only partially pushed into the spindle housing 14.

FIGS. 2a through 2c show that the spindle assembly 40 and the rotary feedthrough module 30 may be handled as separate modules.

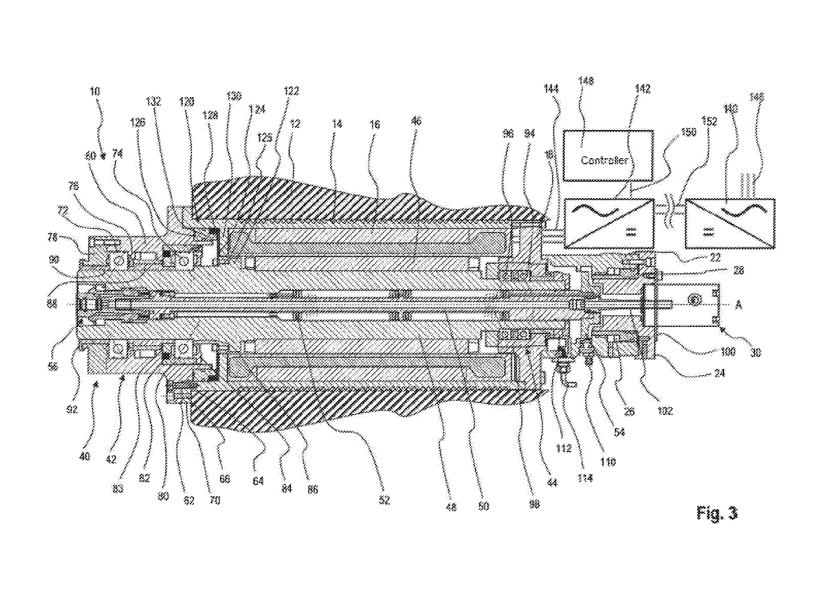

FIG. 3 shows a second embodiment variant of the invention, which with regard to the design of the motor spindle 10 is identical to the first embodiment according to FIG. 1, for which reason the same reference numerals are used for the same components. In individual cases, in automation technology it is necessary to design machines with an inverter or a combination of a rectifier and an inverter. For this reason, the second embodiment of the invention provides for fixedly mounting a combination of a rectifier 140 and an inverter 142 directly on the spindle housing 14. The inverter 142 which is coordinated with the integrated electric motor drive of the motor spindle 10 is connected to the motor spindle 10 via a supply line 144. The rectifier 140 is connected to the power grid via a supply line 146. Also apparent is a controller 148, which is connected to the inverter 142 via a control line 150. The rectifier 140 and the inverter 142 are connected to one another via a connecting line 152.

Alternatively, it is possible to integrate only the inverter 142 into the machine tool or to associate it directly with the motor spindle, wherein the controller 148 and the rectifier 140 are remotely situated, i.e., not integrated.

This embodiment variant with an integrated inverter 142, optionally also with an integrated rectifier 140 and an integrated controller 148, offers the advantage that the particular inverter arrangement may once again remain on the spindle housing 14 in the machine tool 12 when the spindle assembly 40 is replaced, and does not have to be changed out as well. This additionally simplifies the handling.

1. A motor spindle for a machine tool, comprising:
a spindle housing for stationary mounting on the machine,
a spindle assembly, removable from the spindle housing, with a rotor that is supported in an integrated bearing unit so as to be rotatable relative to the spindle housing, and
a clamping mechanism for a tool, the clamping mechanism being actuatable via a clamping piston that is movable in an annular cylinder in the spindle housing,
wherein the spindle assembly is designed with internal cooling that is suppliable with a cooling fluid via a coolant supply, wherein the coolant supply has a rotary feedthrough with an interface between a stationary component and a rotating component of the coolant supply,
and wherein the bearing unit is also removable when the spindle assembly is removed from the spindle housing,
wherein the rotary feedthrough is designed as a rotary feedthrough module that is situated in an area on the spindle housing that is axially outside the annular cylinder.

2. The motor spindle according to claim 1, wherein
the bearing unit has a first bearing assembly situated near the rotary feedthrough module, viewed in the axial direction, and a second bearing assembly situated remote from the rotary feedthrough module, via which the rotor is supported relative to the spindle housing.

3. The motor spindle according to claim 1, wherein
the first and second bearing assemblies each have a bearing bush, rotatably fixedly mounted in the installed state, in which the respective bearing assembly is accommodated, each bearing bush being removable together with the spindle assembly when it is removed from the spindle housing.

4. The motor spindle according to claim 1, wherein
the first and second bearing assemblies each have a pair of roller bearings that are situated in a predetermined orientation relative to one another.

5. The motor spindle according to claim 4, wherein
the pair of roller bearings each has two angular contact ball bearings that are accommodated in the respective bearing bush in an X arrangement or in an O arrangement.

6. The motor spindle according to claim 5, wherein
the pair of roller bearings is accommodated in the respective associated bearing bush in a mutually fixedly clamped arrangement.

7. The motor spindle according to claim 3, wherein
the bearing bush is pretensionable with at least one spring-pretensioned and/or hydraulically actuatable and/or pneumatically actuatable bearing tensioning device for operating the motor spindle.

8. The motor spindle according to claim 1, wherein
the spindle assembly is designed with an axial transfer tube which in the mounted state extends through the clamping piston and into the rotary feedthrough module.

9. The motor spindle according to claim 1, wherein
the rotary feedthrough module has a rotary feedthrough bearing unit that directly or indirectly supports the rotating component of the coolant supply with respect to the spindle housing.

10. The motor spindle according to claim 8, wherein
the transfer tube is accommodated in the rotating component in the rotary feedthrough module and is supported by same.

11. The motor spindle according to claim 9, wherein
the rotary feedthrough bearing unit has at least one roller bearing or slide bearing.

12. The motor spindle according to claim 1, wherein
the rotary feedthrough is designed to press the rotating component and the stationary component against one another in a sealing manner under elastic force and/or by hydraulic and/or pneumatic means.

13. The motor spindle according to claim 1, wherein
the rotary feedthrough module is flange-mounted on the end-face side of the spindle housing by means of a mounting flange.

14. The motor spindle according to claim 1, wherein
the rotor is provided on a radially outer section with a clamping element, which via a hydraulically, pneumatically, or electromagnetically actuatable actuator is clampable against a retaining section of the spindle housing for nonrotatably fixing the rotor relative to the spindle housing.

15. The motor spindle according to claim 14, wherein
the clamping element is designed as a radially extending, deformable clamping plate which is rotatably fixedly connected to the rotor, and which via the actuator may be brought into clamping engagement with the retaining section.

16. The motor spindle according to claim 14, wherein
the actuator is designed in the form of a piston that is pretensioned into a position that releases the clamping element, and is actuatable by being acted on by a hydraulic or pneumatic fluid.

17. The motor spindle according to claim 1, wherein
the spindle housing is designed with an integrated electrical inverter, wherein the inverter remains on the spindle housing when the spindle assembly is removed from the spindle housing.

18. A machine tool that is designed with a motor spindle according to claim 1.

19. A method for inserting and removing a spindle assembly from a spindle housing for a motor spindle according to claim 1, wherein the rotor together with its bearing unit is removable from the spindle housing, and wherein in addition the rotary feedthrough module is removable from the spindle housing and mountable on same, independently of the rotor.
